(19) United States
(12) Patent Application Publication
(10) Pub. No.: US 2010/0264261 A1
(43) Pub. Date: Oct. 21, 2010

(54) AIRCRAFT DRAG MANAGEMENT STRUCTURE

(75) Inventors: Zoltan S. Spakovszky, Cambridge, MA (US); Parthiv N. Shah, San Diego, CA (US); Darius D. Mobed, Allston, MA (US); Jack L. Kerrebrock, Lincoln, MA (US)

Correspondence Address: Technology Licensing Office;Masachusetts Institute of Technology, Five Cambridge Center, Kendall Square, Cambridge, MA, 02142-1493, US

(73) Assignee: Massachusetts Institute of Technology

(21) Appl. No.: 12/600,911

(22) PCT Filed: Dec. 15, 2008
(86) PCT No.: PCT/US08/86791

§ 371 Date: Jun. 24, 2010

Related U.S. Application Data
(60) Provisional application No. 61/014,168, filed on Dec. 17, 2007.

(51) Int. Cl. B64C 1/38; B64D 41/00; F02K 3/02

(52) U.S. Cl. 244/58; 244/130; 60/226.2

(57) ABSTRACT

Drag management structure. The structure includes a tube having an entrance and exit along a longitudinal axis. At least one row of stationary swirl generating vanes is provided at the entrance, the swirl vanes disposed at an angle with respect to the longitudinal axis selected to produce a steady streamwise vortex in a fluid at the tube exit. A fan rotor may be disposed upstream of the stationary vanes.

This application claims priority to U.S. Provisional Application Ser. No. 61/014,168 filed Dec. 17, 2007, the contents of which are incorporated herein by reference.

### BACKGROUND OF THE INVENTION

This invention relates to an aircraft drag management device and more particularly to a swirl tube design that generates drag at lower acoustic noise levels.

Aircraft on approach must slow down. The airplane is put into a high drag, high lift configuration to slow down. Devices that create drag such as flaps, spoilers and the undercarriage create unsteady flow structures that inherently generate noise. There is a strong correlation between overall noise and drag so that, in the quest for quieter aircraft, one challenge is to generate drag at low noise levels.

It is an object of the present invention, therefore, to provide structure that generates drag at a lower acoustic noise level.

### SUMMARY OF THE INVENTION

In one aspect, the drag management structure according to the invention includes a tube having an entrance and an exit along a longitudinal axis. The structure includes at least one row of stationary swirl generating vanes at the entrance, the swirl vanes disposed at an angle with respect to the longitudinal axis selected to produce a streamwise vortex in a fluid at the tube exit. If desired, there can be a fan rotor upstream of the stationary vanes. In a preferred embodiment, the angle is set in a high-drag, low-noise configuration that is less than the critical value at which vortex breakdown occurs.

Another aspect of the invention is a power extraction device having a turbine located at a wing-tip to extract kinetic energy in a wing-tip vortex.

### BRIEF DESCRIPTION OF THE DRAWING

FIG. 1 is a perspective view of an embodiment of the invention disclosed herein.

FIG. 2 is an exploded view of the embodiment of the invention shown in FIG. 1.

FIG. 3 is a graph showing drag coefficient and overall sound pressure level versus swirl vane angle setting.

FIG. 4 is a cross-sectional view showing the swirl tubes of the invention located at wing tips.

FIG. 5 is a cross-sectional view illustrating a swirl tube located within the fuselage of an aircraft.

FIG. 6 is a perspective view of a conventional turbofan engine including swirl vanes in the mixer section.

FIG. 7 is a perspective view of a conventional turbofan engine with swirl vanes in a blocker door mode.

### DESCRIPTION OF THE PREFERRED EMBODIMENT

The present invention is a novel aircraft drag management concept to reduce aircraft noise particularly during approach and to improve fuel burn in cruise. The invention is based on a swirling exhaust flow emanating, for example, from a jet engine nacelle or a wing-tip mounted duct. It is known that a swirling exhaust flow includes a low pressure region in the vortex core and this low pressure can be utilized to increase drag. In a streamwise vortex, the centripetal acceleration of fluid particles is balanced by a radial pressure gradient. The very low pressure near the vortex core at the exit of a duct generates pressure drag. The highest achievable stably swirling flow is limited by an instability called vortex breakdown. If stable, such a streamwise vortex yields a quiet acoustic signature.

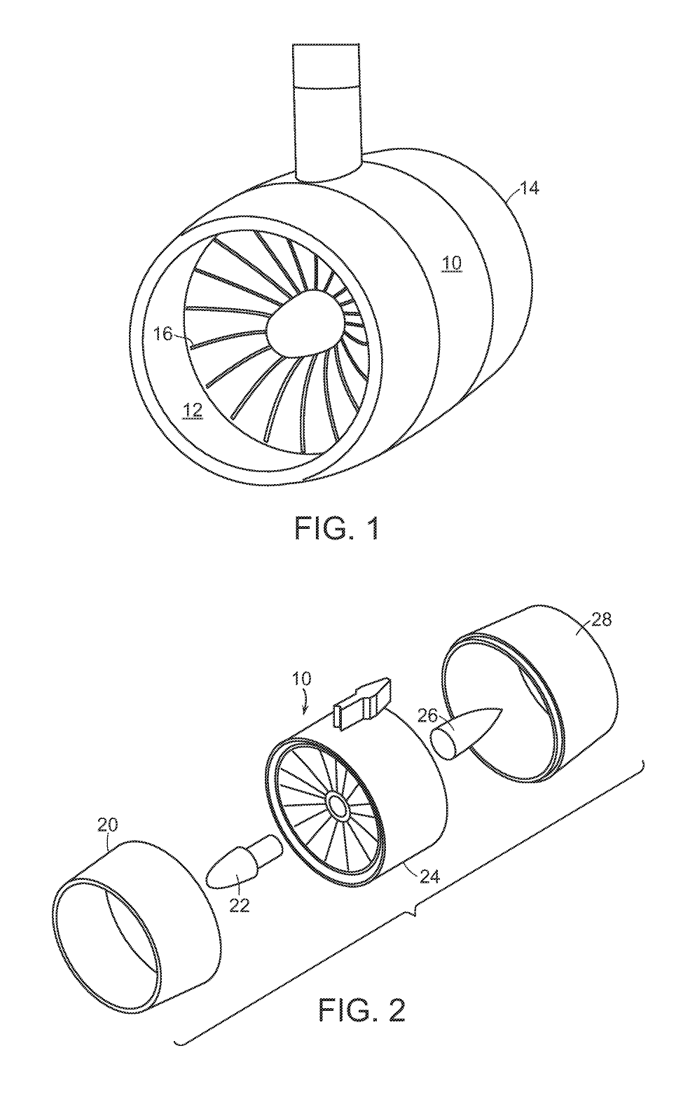

With reference first to FIGS. 1 and 2, a tubular structure 10 has an entrance 12 and an exit 14. A row of stationary swirl vanes 16 is placed near the entrance 12. The swirl vanes are set at an angle with respect to a longitudinal axis of the tubular structure 10. Because the swirl vanes 16 are angled, fluid passing through the tubular structure 10 will rotate forming a streamwise vortex and yielding a swirling flow. As mentioned above, the swirling flow increases drag.

With reference now to FIG. 2, the swirl tube structure 10 includes a forward nacelle 20, a forward centerbody 22, a fixed or deployable swirl vanes section 24, an aft centerbody 26, and an aft nacelle 28. The vanes in the swirl vanes section 24 may have variable pitch capability.

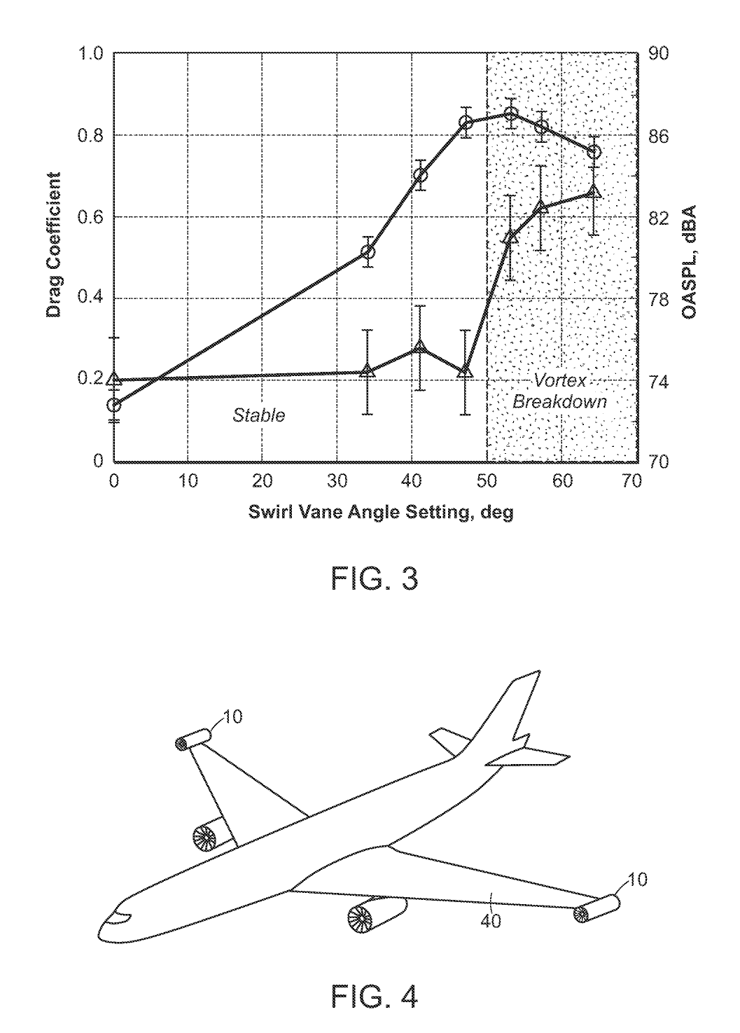

A rigorous aero-acoustic assessment of the ram-air driven structure 10 was conducted in a wind tunnel at the Massachusetts Institute of Technology and in an anechoic free jet facility at NASA Langley at a full scale aircraft approach Mach number of 0.17. At the highest stable swirl angle setting before the onset of vortex breakdown, a nacelle area based drag coefficient of 0.83 was achieved with a full scale overall sound pressure level (OASPL) of about 40 dBA at the International Civil Aviation Organization (ICAO) approach certification point. In this experiment, a highest stable swirl angle setting of 47 degrees was achieved. FIG. 3 is a graph showing drag coefficient versus swirl vane angle setting along with noise versus swirl vane angle setting. The achieved drag is comparable to the drag of a bluff body of the same diameter as the structure 10 but at noise levels quieter than the sound pressure level in an average home.

With reference to FIG. 4, swirl tubes 10 are shown located at the ends of wing 40. As discussed earlier in conjunction with FIG. 1, the structure 10 includes a row of fixed vanes that are angled to provide a swirling flow. On approach and landing, the vanes are set to provide drag with low noise. At cruise, however, the vanes can be adjusted to provide swirling flow rotating in a direction opposite to that of vortices that are naturally trailing from the tips of the wing 40 thereby reducing vortex-induced drag. Those of skill in the art will recognize that the vanes in the structure 10 could also be rotatable so that power could be extracted from wing tip vortices during cruise to power an auxiliary power unit.

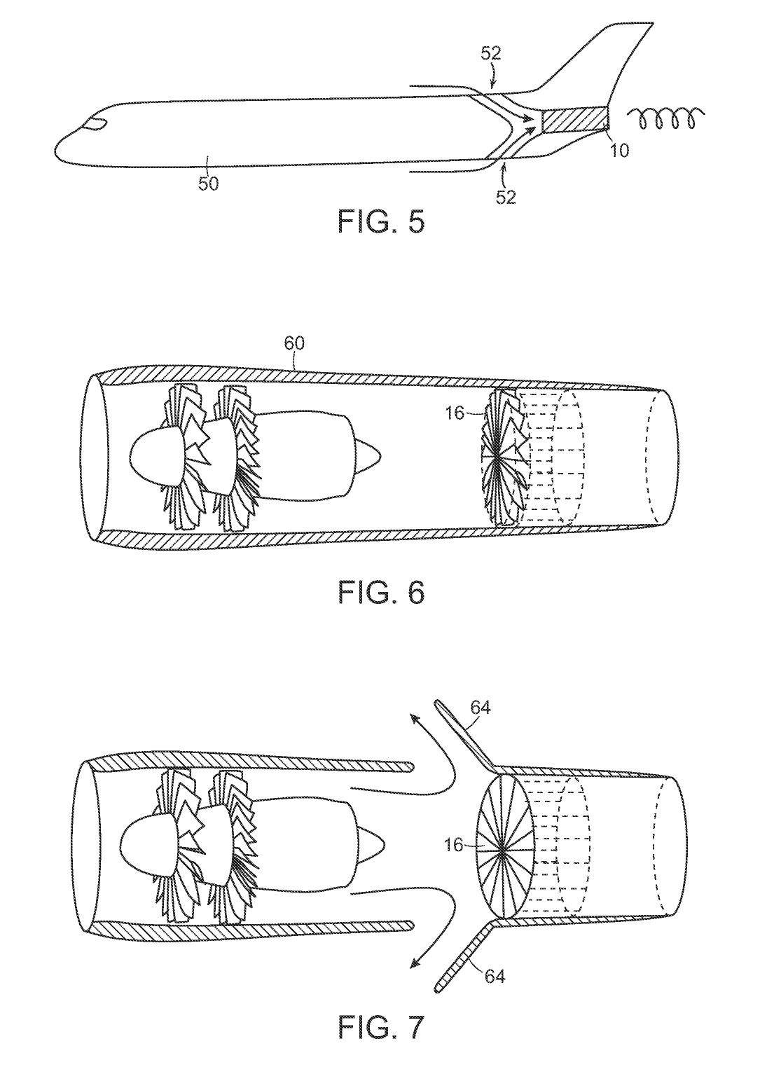

As shown in FIG. 5, the swirl tube 10 may be located within a fuselage 50 of an aircraft. Air is introduced through an inlet door 52, passes through the swirl tube 10 and exits at the rear of the fuselage 50.

With reference to FIG. 6, a conventional turbofan engine 60 includes swirl vanes 16 deployed in a mixer section of the engine 60. This configuration allows the swirl vanes 16 to allow the engine 60 to operate as an air brake to generate aircraft drag on landing and approach. As shown in FIG. 7, the vanes 16 can be closed and used as blocker doors 64 opened to provide reversed thrust after touchdown.

Returning to FIG. 4, it will be appreciated that the swirl tubes 10 can be used for vehicle control serving, for example, as yaw moment generators at the wing tips.

It is recognized that modifications and variations of the invention disclosed herein will be apparent to those of skill in the art and it is intended that all such modifications and variations be included within the scope of the appended claims.

What is claimed is:

1. Drag management structure comprising:
a tube having an entrance and an exit along a longitudinal axis; and
at least one row of stationary swirl generating vanes at the entrance, the swirl vanes disposed at an angle with respect to the longitudinal axis selected to produce a stable, stream-wise vortex in a fluid at the tube exit.

2. The structure of claim 1 wherein the angle in a high drag, low noise setting produces stable swirling outflow.

3. Power extraction device comprising:
a turbine located at a wing-tip to extract kinetic energy in a wing-tip vortex.

4. The drag management structure of claim 1 located at the tips of a wing.

5. The drag management structure of claim 1 located within the fuselage of an aircraft.

6. The drag management structure of claim 1 located in the mixer section of a turbo fan engine.

7. The drag management structure of claim 6 wherein variable pitch swirl vanes are closed and act as thrust reverser blocker doors.

8. The drag management structure of claim 1 further including a fan rotor upstream of the stationary vanes.

9. The drag management structure of claim 1 wherein the vanes have variable pitch capability.
